(19) United States
(12) Patent Application Publication
(10) Pub. No.: US 2019/0203836 A1
(43) Pub. Date: Jul. 4, 2019

(54) TEMPERATURE-CONTROL DEVICE WITH SPRING ELEMENT

(71) Applicant: REINZ-DICHTUNGS-GMBH, NEU-ULM (DE)

(72) Inventors: WERNER BUNTZ, MUEHLHAUSEN (DE); MATTHIAS PENDZIALEK, ULM (DE)

(21) Appl. No.: 16/311,958

(22) PCT Filed: Jun. 29, 2017
(86) PCT No.: PCT/EP2017/066108

§ 371 Date: Dec. 20, 2018

(30) Foreign Application Priority Data
Jun. 29, 2016 (EP) PCT/EP2016/065177
Jun. 29, 2016 (EP) PCT/EP2016/065183
Dec. 22, 2016 (EP) 20 2016 107 299.9

(51) Int. Cl. F16J 15/06; F16J 15/08; F16K 15/02; F16K 15/14; F01M 5/00; F01P 11/10

(52) U.S. Cl. CPC F16J 15/064; F16J 15/0825; F16K 15/023; F16N 2280/00; F01M 5/002; F01P 11/10; F16K 15/144

(57) ABSTRACT

A temperature-control device for cooling or heating a heat exchanger fluid is disclosed. The device may have a base plate and a heat exchanger element. The base plate may have at least one throughflow opening as an inlet or outlet for the heat exchanger fluid. Furthermore, the temperature-control device may have a spring element which has a spring plate and a retaining region for the spring plate, which retaining region is connected to the spring plate and surrounds the latter at least in some regions. A spring plate seat for abutment for the spring plate may be included, and optionally a receiving region for receiving the spring element in and/or adjacent to the base plate. The spring plate, in a projection of the spring plate perpendicular to the areal extent thereof, is arranged within the throughflow opening.

The invention relates to a temperature-control device for cooling or heating a heat exchanger fluid. The invention is also directed to an oil cooler and a hydraulic system having a temperature-control device according to the invention, and to an internal combustion engine having a hydraulic system according to the invention and/or an oil cooler according to the invention and/or a temperature-control device according to the invention.

As the heat exchanger fluid in temperature-control devices of motor vehicles, use is made in particular of oil, water (optionally mixed with additives) and air. The fundamental purposes of oil include, inter alia, lubrication, force transmission, corrosion protection and the cooling of components. Particularly in internal combustion engines, the high boiling point of oil makes it possible to cool components which are subjected to high thermal loads, for example the pistons and the crankcase. In order not to excessively impair the lubrication properties and the service life of the oil, the temperature of the oil must not rise or fall excessively. Particularly the downsizing of engines places high demands on the oil, because the smaller installation space with a smaller crankcase surface area and the increased component density reduce the possibility of dissipating heat from the engine and the oil. At the same time, the forced induction of engines leads to higher combustion chamber temperatures, which means that more efficient dissipation of heat by cooling the oil is necessary. In other applications, however, for example the temperature-control of fuel, that is to say petrol or diesel, air may suffice as the heat exchanger fluid.

Conventionally, temperature-control devices contain a base plate, which can serve to define the shape of the temperature-control device and to fasten the temperature-control device to a counterpart component and to close the temperature-control device. At least one throughflow opening is arranged in said base plate as an inlet or outlet for the heat exchanger fluid. Heat exchanger fluid which has passed via the inlet into the temperature-control device can give off or absorb heat along at least one heat exchanger element. The heat transfer within the heat exchanger element takes place optionally between oil and water or between oil and air. Valves are used to regulate the throughflow of heat exchanger fluid in the temperature-control device. For this, use is usually made of valves which, in orthogonal projection onto the plane of the base plate, are arranged so as to overlap with at least one throughflow opening. The valves are fastened by being pressed into one of the surfaces of the base plate or into a connecting piece attached thereto. Disadvantages of such conventional valves are that the valve usually consists of multiple component elements, must be integrated into the system as an additional part and thereby increases the number of components and the complexity. Furthermore, in order to use such valves, existing systems have to be specifically adapted, such valves being installed subsequently in a separate operating step. Finally, the valves have a comparatively large component volume, as a result of which an excessive amount of installation space is necessary. Often, specifically provided cutouts must be made in the counterpart component in order to be able to accommodate the valves.

It is therefore an object of the invention to provide a temperature-control device which allows simple and cost-effective integration into existing systems. The valve should be able to be integrated in as space-saving a manner as possible and with the lowest possible assembly effort. Finally, rapid and smooth opening and closing of the valves must be ensured, as well as reliable sealing when the valve is in the closed state. A further object is to provide an oil cooler, a hydraulic system and an internal combustion engine which have such a temperature-control device.

The object is achieved by the temperature-control device according to claim 1, the oil cooler according to claim 22, the hydraulic system according to claim 23, and the internal combustion engine according to claim 24. Advantageous developments of the temperature-control device according to the invention are given in the dependent claims.

The temperature-control device according to the invention for cooling or heating heat exchanger fluid has at least one heat exchanger element and a base plate which has at least one throughflow opening as an inlet or outlet for the heat exchanger fluid. Said temperature-control device also comprises a spring element which has a spring plate and a retaining region which is connected to the spring plate, as well as a spring plate seat for abutment for the spring plate. The parallel projection of the spring plate perpendicular to the areal extent thereof is arranged within the throughflow opening. The spring plate can be used to close and then open a fluid channel, in particular an oil channel, and thus to enable or prevent a flow of heat exchanger fluid, in particular an oil flow, through the throughflow opening, wherein the spring plate may close the throughflow opening in the base plate itself or another opening, for example an opening arranged in an additional functional layer. It is also possible to limit the throughflow instead of preventing it. The temperature-control device according to the invention may also have a receiving region, also referred to as an abutment region.

A connecting region and a retaining region surround the spring plate at least in some regions, wherein the connecting region fixes the spring plate in position relative to the temperature-control device, for example on the base plate, on an additional layer or on a counterpart component. In the radially outward direction, the spring plate transitions into the retaining region and the latter transitions into the connecting region, optionally via a deflection region located therebetween. The connecting region serves to receive the spring element in the temperature-control device, that is to say in and/or adjacent to the base plate. The temperature-control device according to the invention additionally has a spring plate seat as an abutment for the spring plate.

Such a temperature-control device enables easy integration of the spring element, which reduces the number of components and the system complexity. By integrating the spring element in the temperature-control device, there is also no need for any additional assembly effort. The spring element can also have very small dimensions due to its simple design. In addition, it can be arranged within the throughflow opening, as a result of which the risk of mechanical damage is reduced. This also enables a particularly space-saving integration in the temperature-control device. Due to the space-saving design, the system can also be combined in a very flexible manner with different systems and various neighbouring components, for example an engine block or other counterpart components, and can be used in such. Finally, the small dimensions and the associated low inertial mass of the spring plate also ensure rapid and smooth opening and closing of the spring plate.

The temperature-control device according to the invention may have additional layers adjacent to the base plate, said additional layers advantageously running parallel to the plane of the base plate. It has at least one throughflow opening, which usually extends through at least one region of the temperature-control device and optionally also through additionally provided layers and through optionally provided further functional elements such as connecting pieces. This means that the optionally provided additional layers and functional elements may also have an opening. In this case, the clear widths of the openings in the optionally provided individual layers and additional functional elements may be of different or equal size. The openings may also have different shapes or may be subdivided into part-openings. It is particularly advantageous if some or all of said openings are arranged in alignment with one another or at least concentric to one another, but they may also be non-concentric. The throughflow opening therefore extends through layers and elements of the temperature-control device but need not necessarily run continuously perpendicular to the plane of the base plate, but rather may also have an offset or branches.

In an advantageous embodiment, the temperature-control device has a connecting piece which is arranged on one side of the base plate and optionally is connected thereto or engages through the base plate. The connecting piece may be connected to the base plate in a force-fitting, form-fitting and/or materially bonded manner. In particular, the connecting piece may be welded to the base plate. The connecting piece offers the possibility of connecting a flexible elongate hollow body, for example a hose for conveying heat exchanger fluid. To this end, the free end of the connecting piece preferably points away from the at least one heat exchanger element. The wall of the connecting piece may, at least in some regions, in particular in its region of contact with the base plate, be arranged so as to run around the throughflow opening, advantageously concentric to the throughflow opening. The opening cross-section of the connecting piece then advantageously overlaps with the opening cross-section of the throughflow opening in the base plate.

The spring element may in some sections adjoin the base plate and at least in some sections may be arranged within the region delimited by the connecting piece. In particular, the connecting region and/or retaining region of the spring element may be connected in a materially bonded, form-fitting and/or force-fitting manner to the base plate, to the connecting piece, to a further layer and/or to a counterpart component.

The temperature-control device has a spring plate seat for abutment for the spring plate. This may be configured as part of the spring element, of the base plate, of an additional layer, of a further functional element, of a connecting piece and/or of a counterpart component. A spring plate seat in the spring element itself is preferably combined with a spring plate seat in an adjacent component.

The temperature-control device advantageously has a spring plate seat with a through-opening. The through-opening may also be formed in the spring element, in the base plate, in an additional layer such as a functional layer, in an additional functional element, in a connecting piece, in a counterpart component or in a further component. In a base plate, a connecting piece or a counterpart component, it would therefore be referred to as a throughflow opening. The projection of the through-opening perpendicular to the areal extent thereof lies within the spring plate. In other words, the clear width of the through-opening is smaller than the diameter of the spring plate. The orthogonal projection of the through-opening thus also lies within the throughflow opening. The through-opening and the throughflow opening thus form a possible passage for the heat exchanger fluid. It is particularly advantageous if the through-opening and the throughflow opening are arranged concentric to one another, but they may also be non-concentric.

A spring plate seat for abutment for the spring plate is arranged so as to run around said through-opening. Said spring plate seat may be configured as part of the spring element, of the base plate, of an additional layer such as a functional layer, of a further functional element, of a connecting piece, of a counterpart component or of a further component. The spring plate may then optionally have a larger diameter than the clear width of the opening and may at least in some regions rest on the spring plate seat in the state of the spring plate in which no pressure is applied or in the closed state of the throughflow opening. The spring plate seat comprises at least the contact face, that is to say the face at which the spring plate and the abutment make contact. The spring plate seat may also include a region adjacent to the contact face. This means that the spring plate seat may be formed by a region adjacent to the circumferential edge of a through-opening. Here, an adjacent region is to be understood to mean the region that directly adjoins the circumferential edge of the opening.

The spring plate seat and the spring plate together form a valve, the opening of which is provided by the through-opening in the spring plate seat. If a through-opening is also provided in the spring plate itself, a shutter-type check valve is created rather than a simple valve.

Advantageously, the spring plate seat has an elevation element, for example an embossed elevation element such as a bead or (for example corrugated) profile, a metal ring, a flange, a planar elastomer coating or a rubber element which is applied for example by injection moulding, said elevation element protruding in the direction of the spring plate. The spring plate may rest partially or completely on this elevation element.

If the elevation element is formed in the spring plate itself, the spring plate with the elevation element rests on another component, which preferably has a further spring plate seat, wherein the latter may in this case be configured without an elevation element.

However, it is also possible to configure the spring plate and the spring plate seat with an elevation element, wherein the spring plate, the spring plate seat and the elevation element come to lie on one another. As a result, it is possible to achieve a larger elevation than in a single layer.

The elevation element therefore forms an abutment for the spring plate, which abutment on the one hand improves the sealing between the spring plate seat and the spring plate and on the other hand preloads the spring plate counter to the throughflow direction. The opening behaviour of the spring plate can be defined by the design of this elevation element and by the preloading of the spring plate by means of its retaining elements and/or an optionally provided deflection region.

In an advantageous development, the temperature-control device comprises a first functional layer, in particular a sealing layer, which is arranged adjacent to the surface of the base plate and has a spring plate seat and a through-opening. The functional layer may be, for example, a thin metal layer. This may be coated at least in some regions, for example by an elastomer coating applied at least in some regions, in order to achieve an improved sealing effect. In addition, the functional layer may have sealing beads. The functional layer enables particularly good sealing in the region of the spring plate seat and between the base plate and an adjacent component, the counterpart component. Compared to other gaskets, this gasket is particularly advantageous because it can provide an excellent sealing effect while taking up a small amount of space by using beads and coatings.

The spring plate and the retaining region may be formed integrally. The connecting region outside of the retaining region may also be formed integrally with the retaining region. This has the advantage that no individual components have to be joined to one another, which considerably reduces the assembly effort. In this construction, the manufacturing outlay for the spring element is comparatively very low.

In a particularly advantageous development, the spring element is configured as part of an entire layer, that is to say the spring element is contained in a layer, which can also be referred to as a spring layer. In particular, the clear width of the spring element including the retaining region thereof may be greater than or equal to twice the diameter of the throughflow opening, in particular greater than or equal to twice the minimum diameter of the throughflow opening in the base plate. In particular, the spring plate, the retaining region and the connecting region may be configured as part of the spring layer or of a further layer arranged adjacent to the base plate, in particular the first functional layer. A further reduction in complexity can be achieved as a result, because the number of different components is further reduced. The assembly effort and manufacturing outlay are likewise further reduced. In this development, no receiving region is necessary in the temperature-control device.

In an alternative development, the spring element is not configured as part of an entire layer but rather as a separate spring element and/or functional element which is not contained in a layer, that is to say is not an integral and materially uniform part of such a layer. In particular, the clear width of the spring element including the retaining region thereof may in this case be smaller than twice the diameter of the throughflow opening, in particular smaller than twice the minimum diameter of the throughflow opening in the base plate. In this case, the spring element may advantageously be received in a recess, adjacent to the throughflow opening, in at least one surface for example of the base plate, of the connecting piece, of another layer or of a counterpart component.

The spring element may be fastened in a materially bonded, form-fitting and/or force-fitting manner.

For example, the spring element may, in the retaining region, be welded to the base plate, to the connecting piece, to a further layer and/or to a counterpart component, so that a materially bonded connection is achieved.

Form-fitting connections are advantageous in particular in, but not limited to, embodiments in which the spring element is not part of an entire layer.

In a particularly advantageous embodiment, a receiving region is configured as a first recess in the base plate, in an additional layer or in a counterpart component, which recess runs around the circumferential edge of the throughflow opening at least in some sections and is set back in a step-like manner from the surface of the base plate, of the additional layer or of the counterpart component around the circumferential edge of the throughflow opening. In this embodiment, therefore, the base plate, an additional layer or a counterpart component has on a first side, around the circumferential edge of the at least one throughflow opening, a first step-like first recess which is set back from the throughflow opening. This recess may be provided continuously around the circumferential edge or else only in some sections. The spring element can be mounted in this recess. The connecting region and/or retaining region protrudes into the recess. The form fit is thus achieved, at least on one side, by a wall of the recess. On the other side, the form fit can be ensured by a further component, for example the base plate, a further layer, a connecting piece or a counterpart component. Such an embodiment may be advantageous if the spring element can be realized as part of an entire layer only with difficulty or if this is not desired for design reasons.

A force-fitting connection may be advantageous in particular in, but not limited to, embodiments in which the spring element is contained in a layer. In this case, the layer containing the spring element may be located between components such as counterpart components, layers or functional elements; a force-fitting connection can be established by a force orthogonal to the plane of the layer containing the spring element. Such a force or normal force can be achieved in particular when the components located opposite one another are joined to one another by releasable or non-releasable connecting elements. A recess as in the preceding embodiment is not required in this case.

With particular advantage, the connecting region and/or retaining region of the spring element is arranged and/or fastened between the base plate and the first functional layer, a further layer and/or a counterpart component. Advantageously, the planes of the base plate and of the first functional layer, of a further layer and/or of a counterpart component are arranged parallel to one another. The layers may be connected relative to one another in a force-fitting, form-fitting or materially bonded manner. A particularly secure way of fastening the connecting region and/or retaining region and thus the spring element is thereby achieved, since the force for fastening and fixing the spring element can be transmitted over a large area.

In an advantageous development, the spring element is arranged within the region which is delimited by the base plate and optionally provided layers of the temperature-control device. In other words, no regions of the spring element protrude outwards, and the contour of the temperature-control device is not formed by a part of the spring element.

Even in embodiments in which the spring element forms a part of the outer contour, the region of the contour formed by the spring element is at least very small. A particularly space-saving construction is possible as a result, which can easily be integrated with other components and in addition does not entail any risk of damage to components, injury or harm.

Advantageously, the connecting region and/or retaining region of the spring element, at least in some regions, is configured to run around and adjacent to the throughflow opening. This type of construction enables a space-saving shape. In addition, the receiving of the spring element can be ensured via the retaining region close to the spring plate, an optionally provided deflection region and the connecting region in or adjacent to the base plate.

In addition, the spring plate is preferably fastened to the retaining region via one or more retaining arms, which are part of the retaining region. In the radially outward direction, the spring plate may be connected via retaining arms to the deflection region and/or connecting region adjoining the retaining region of the spring element. Preferably, the spring plate is integrally connected to the deflection region and/or connecting region via one retaining arm, two retaining arms, three retaining arms, four retaining arms or more than four retaining arms, wherein the at least one retaining arm may be branched. Advantages of this embodiment are that the arms are easy to manufacture, in particular by punching, and that there is no need for any additional effort for joining individual parts. A branched design increases the service life of the retaining region. Preferably, multiple identical retaining arms with a substantially equal spacing are provided on the retaining region of the spring element, so that the spring plate opens and closes substantially parallel to the plane of the spring plate seat.

In an advantageous embodiment, the retaining region of the spring element is surrounded by a deflection region, as a result of which the spring element is deflected relative to the plane in which the connecting region of the spring element extends, in particular is deflected to the same extent all the way round. The deflection is preferably formed as a circumferential, plastic half-bead and therefore has an approximately z-shaped cross-section on one side of the spring plate.

The retaining region may also be plastically pre-deformed, namely such that, in the state in which no pressure is applied to the spring plate, the section of the retaining region or of the retaining arms furthest from the plane of the spring plate seat is offset relative to the plane in which the actual spring plate extends. The retaining arms extend radially outwards, that is to say away from the plane of the spring plate seat in the state in which no pressure is applied. Preferably, the spring plate bears against the spring plate seat with preloading in the state in which no pressure is applied. The spring element of this embodiment will be referred to below as a compression spring. The offset is preferably at least 0.4 mm.

In an alternative embodiment, the retaining region has no plastic pre-deformation but rather, in the state in which no pressure is applied to the spring plate, extends in the plane of the spring plate or, in the region running around the spring plate seat, even from the plane of the spring plate to behind the plane of the spring plate seat. There is an elastic pre-deformation in the latter case and no preloading at all in the former case. These two embodiments will be referred to below as tension springs.

In an advantageous development, the retaining arms may for example depart from the spring plate in a spiral-shaped manner. If the spring plate is then deflected perpendicular to its areal extent, it exposes the through-opening. In the case of a compression spring, the throughflow cross-section between the retaining arms decreases as the deflection of the spring plate increases. In the case of a tension spring, the openings between the spiral arms widen and allow the heat exchanger fluid to pass through. As the deflection of the spring plate of a tension spring increases, the throughflow cross-section between the retaining arms increases, via which the heat exchanger fluid can flow through between the outer circumferential edge of the throughflow opening and the outer circumferential edge of the spring plate. In both embodiments, it is possible to influence the flow behaviour of the heat exchanger fluid passing through.

Advantageously, a predefined spring characteristic of the retaining arms perpendicular to the areal extent of the spring plate, for example a linear or non-linear, in particular degressive spring characteristic curve, is achieved by the design of the retaining arms, for example by a spiral shape of the retaining arms. The lifting of the spring plate away from its spring plate seat or abutment can thereby be controlled.

The temperature-control device according to the invention enables the situation whereby the heat exchanger fluid can flow through the at least one throughflow opening only in one direction, in the present example in the direction in which the spring plate lifts away from its abutment on the first functional layer due to the pressure of the heat exchanger fluid. This direction will be referred to below as the main flow direction. As a result, an (annular) gap opens between the circumferential edge of the through-opening in the first functional layer and the spring plate, so that the heat exchanger fluid can flow through this gap and onwards through the through-opening to the other side of the temperature-control device. As an alternative or in addition, through-openings may be arranged in the spring element outside of the spring plate, for example in the optionally provided deflection region. Given a suitable design of the spring element, these through-openings may nevertheless be closed in the closed state of the spring plate. In the opposite direction, the spring plate is pressed onto the spring plate seat by the pressure of the heat exchanger fluid and/or the preloading of the retaining arms and thereby blocks the passage of the heat exchanger fluid through the throughflow opening.

In particular, it is possible to preload the spring plate. For this, a preloading force, that is to say a normal force, can be exerted on the spring plate by a spring, which in particular may be formed by the retaining region. The spring may be configured either as a compression spring or as a tension spring. As a result, a pressing force can be brought about which can prevent the passage of heat exchanger fluid through the through-opening or enables this only when there is a sufficiently large pressure difference in the heat exchanger fluid between the two sides of the spring plate.

In an advantageous development, the spring element, one of the layers, the base plate or a counterpart component has at least one lift-limiting element, also referred to as a travel-limiting element, for limiting the travel of the spring plate in the main flow direction perpendicular to the areal extent of the spring plate. Faster opening and closing of the valve is possible as a result. In addition, the retaining region and the spring optionally formed in the retaining region are placed under less stress if a lift-limiting means is present. Preferably, the lift-limiting element is arranged on the side of the spring element facing away from the spring plate seat.

The lift-limiting element is advantageously arranged within the throughflow opening or in the extension of the through-opening, at a distance from the circumference of the throughflow opening, such that the parallel projection of the spring plate in the lifting direction thereof, that is to say perpendicular to the areal extent thereof, is arranged so as to overlap with the lift-limiting element. Advantageously, the lift-limiting element is arranged concentric to the spring plate so that the spring plate at maximum deflection rests centrally on the lift-limiting element.

The lift-limiting element may take different geometric shapes. For example, it may be a plate-shaped lift-limiting element which is connected to the remaining region thereof via retaining arms; it is also possible to provide only (one or more) arms protruding into the throughflow opening as lift-limiting elements; a protrusion running around the circumferential edge of the throughflow opening is also conceivable, or other symmetrical or asymmetrical geometric shapes.

The lift-limiting element may have a deformation, for example an embossment (for example a bead or a corrugated profile), a metal ring, a flange, or a rubber element, these serving as an abutment for the spring plate in order to limit the opening travel thereof.

The lift-limiting element may advantageously be connected to its adjacent region at least at two connection points. Advantageously, the connection takes place via one or more pairs of adjacent connection points. These may advantageously be arranged along the circumferential edge of the base plate or of an additional layer such that the centres of the connection points are arranged offset from respective adjacent connection points by at least 85° along the circumferential edge of the throughflow opening.

As the connecting elements, use may be made for example of one or more webs which, in parallel projection in the direction of the rotation axis of the throughflow opening, protrude into the throughflow opening and are optionally connected to one another at their ends protruding into the throughflow opening. They may form a common web spanning the throughflow opening or else may form, in the region in which they are connected to one another, a star having three or more web elements. In a further embodiment of the present invention, the connecting element used may also be just one web which protrudes freely into the throughflow opening. It is then advantageous if the web has a minimum width of 0.1 to 0.9 mm and/or is integrally connected to the spring element, from which said web is formed, along a circular segment of at least 25°, advantageously at least 30°, of the circumference of the circumferential edge of the through-opening. The latter is particularly advantageous for individual webs which do not cooperate with further web elements. In individual cases, the web may be connected over up to 180° of the circumference. Usually, however, the connection is no wider than a circular segment of 120°, preferably 90°, in particular 60°.

Particularly advantageous further embodiments of the lift-limiting element will be given below. The lift-limiting element may advantageously be formed integrally with the base plate. In this case, for example, the base plate, in particular the circumferential edge of the throughflow opening formed by the base plate, may be shaped, in particular by embossing with an embossing stamp, such that the clear width or the diameter of the throughflow opening is reduced in some regions. This may be brought about, for example, in that a material bulge is formed inside the throughflow opening as a result of the compression. This material bulge or this reduction in cross-section then forms the lift-limiting element.

Advantageously, the lift-limiting element may be formed integrally with the spring element. For example, a web which serves as a lift-limiting means may be formed from the spring element. With particular advantage, the web is a web which has been bent one or more times, the parallel projection of which in the direction of the lifting movement of the spring plate is arranged so as to overlap with the spring plate, wherein the web in the unbent state is arranged adjacent to the retaining region, in the form of a circular arc, the longitudinal ends of which are connected to the retaining region or to another region of the spring element.

In a further embodiment, the lift-limiting element is formed integrally with the functional layer or with a further layer. In this case, it is likewise particularly easy to form the lift-limiting element as a web.

Alternatively, such a lift-limiting element may also be formed by a second functional element. This second functional element may then have a retaining region which surrounds the circumferential edge of the throughflow opening at least in some regions and can be arranged in a further recess in the base plate, in an additional layer or in a counterpart component. In this case, it is possible to make the depth of the recess correspond to the thickness of the retaining region of the second functional element. As a result, the temperature-control device can advantageously have a smaller thickness.

Advantageously, the lift-limiting element may be mounted elastically and thus may form a flexible stop for the spring plate. The spring rates for the spring plate and for this elastically mounted lift-limiting element can be selected to be different. It is thus possible to make the opening behaviour of the spring plate variable along the opening travel. For example, the lift-limiting element may have a higher spring rate than the spring plate, so that the opening movement of the spring plate, after contact with the lift-limiting element, runs much more slowly or with less deflection for the same pressure on the spring plate.

In addition to this lift-limiting element and in a manner spaced apart therefrom, in particular spaced apart via an angled section, a further, rigid, second lift-limiting element may be provided in a functional layer, in a further layer or in a further functional element, which second lift-limiting element for its part limits the deflection of the first, elastic lift-limiting element. Given a suitable configuration of the spring rates of both the spring plate and the first lift-limiting element, for example if a higher spring rate is used for the lift-limiting element than for the spring plate, it is possible to configure individually the opening characteristics of the spring plate along its deflection.

Profiles or beads arranged in the lift-limiting element, in the spring element, in a functional layer and/or in the spring plate advantageously have a thickness, defined perpendicular to the neutral axis of the layer in question, which is smaller in the flanks of the profile or of the bead(s), preferably ≥15% smaller, preferably ≥22% smaller, than in the regions adjacent in the layer plane. If a flanged region is provided, the thickness thereof may be smaller, preferably ≥8% smaller, than the thickness of the adjacent region. The layer section which is flanged and which includes the free end of said layer therefore has a smaller thickness than the non-flanged section of said layer. However, the flanging produces an overall increase in the thickness of the two layer sections.

The object described in the introduction is also achieved by an oil cooler having a temperature-control device according to one of the preceding embodiments; and by a hydraulic system having a temperature-control device according to one of the preceding embodiments; and finally by an internal combustion engine having a hydraulic system or a temperature-control device according to one of the preceding embodiments.

Some examples of temperature-control devices according to the invention will be given below, wherein identical or similar elements are provided with identical or similar reference signs. The description thereof therefore may not be repeated. The exemplary embodiments below also contain many advantageous developments and features which are also suitable for developing the present invention by themselves, without being considered in combination with the other advantageous features of the embodiment in question. Individual features of different exemplary embodiments can also readily be combined as advantageous developments.

In the figures:

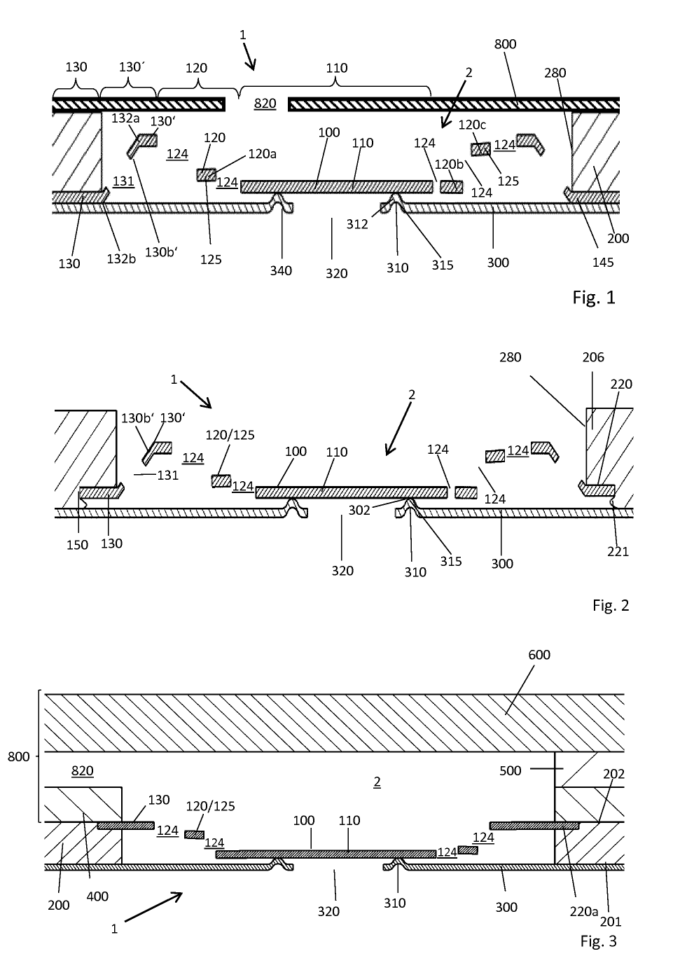

FIG. 1 shows a cross-section through a temperature-control device according to the invention, with a spring layer between the base plate and the functional layer;

FIG. 2 shows a cross-section through a further temperature-control device according to the invention, without a spring layer, when the connecting region of the spring element is fastened between the base plate and the functional layer;

FIG. 3 shows a cross-section through a further temperature-control device according to the invention, without a spring layer, when the connecting region of the spring element is fastened between two layers or plates;

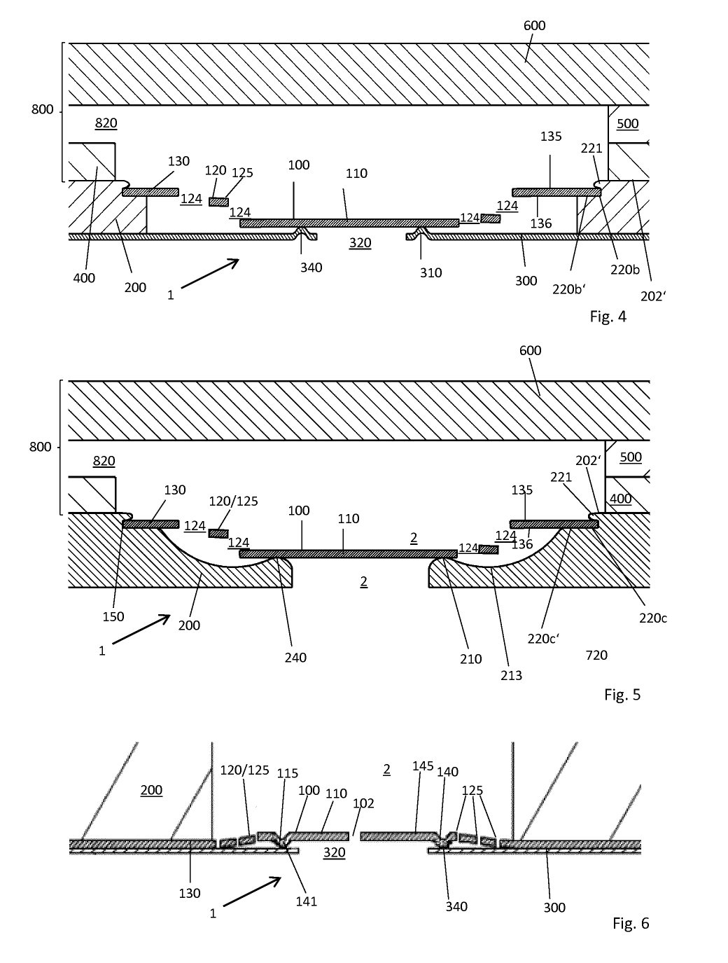

FIG. 4 shows a cross-section through a further temperature-control device according to the invention, without a spring layer, when the connecting region of the spring element is fastened in the base plate;

FIG. 5 shows a cross-section through a further temperature-control device according to the invention, without a spring layer, when the connecting region of the spring element is fastened in the base plate;

FIG. 6 shows a cross-section through a further temperature-control device according to the invention, with a spring layer between the base plate and the functional layer;

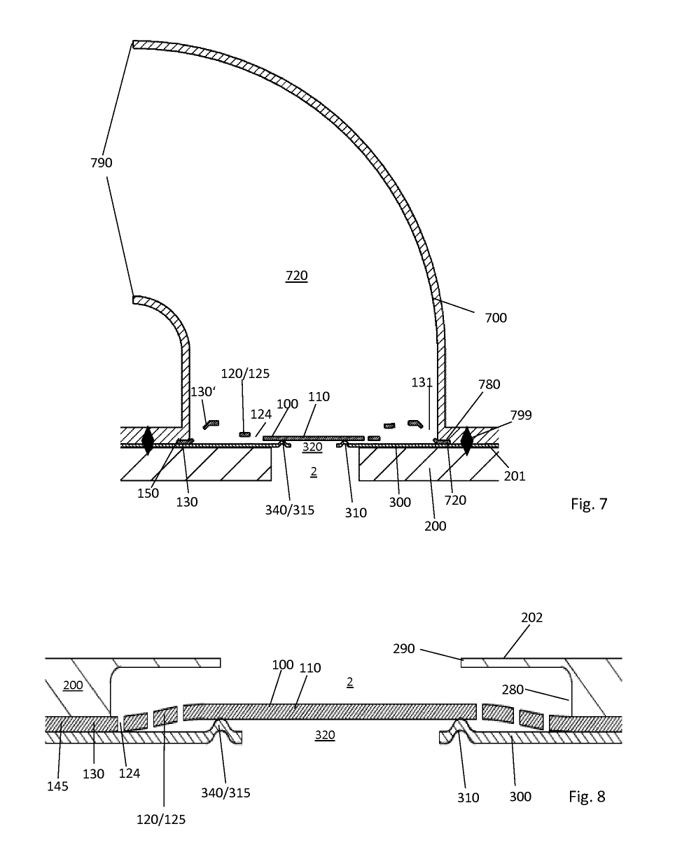

FIG. 7 shows a cross-section through a further temperature-control device according to the invention, without a spring layer, when the connecting region of the spring element is fastened between a functional layer and a connecting piece;

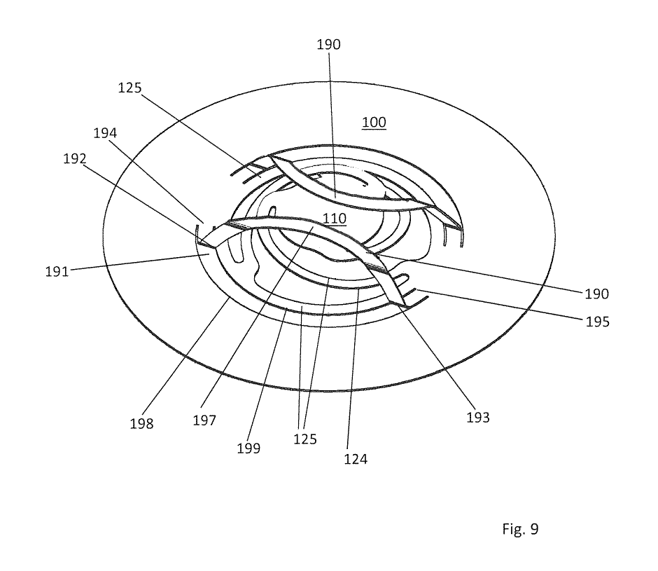

FIG. 8 shows a cross-section through a further temperature-control device according to the invention, with a spring layer between the base plate and the functional layer;

FIG. 9 shows an oblique view of a spring element with a lift-limiting means for use in a temperature-control device according to the invention;

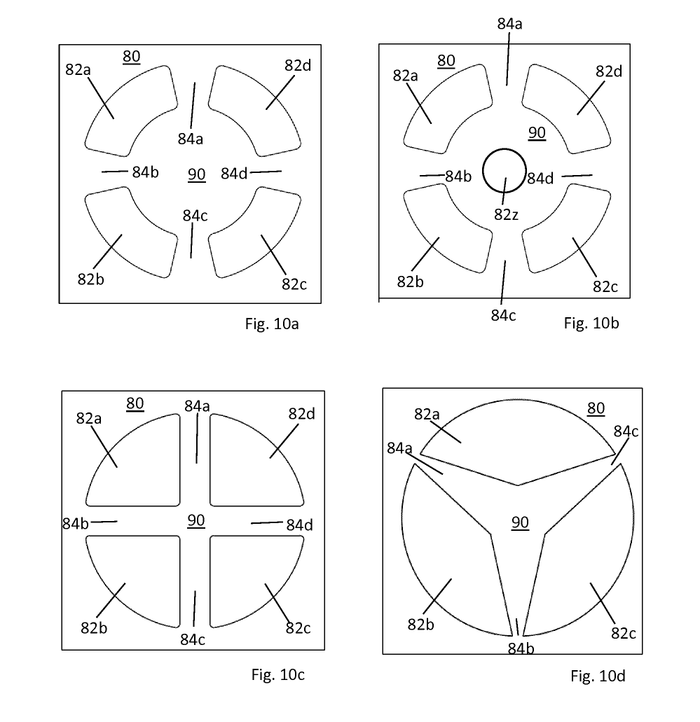

FIG. 10 shows four plan views of lift-limiting elements for use in a temperature-control device according to the invention;

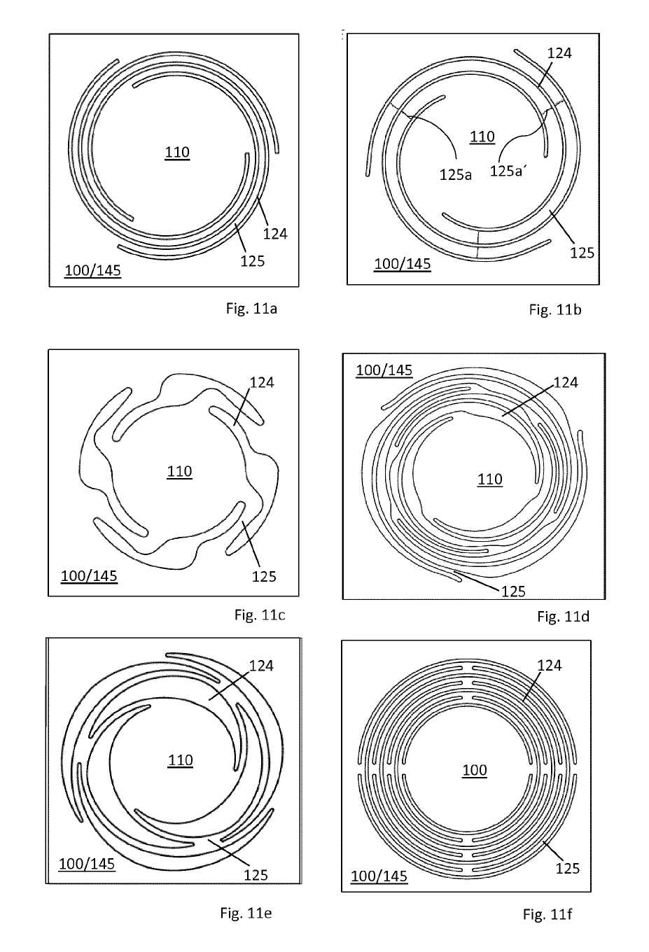

FIG. 11 shows six plan views of spring elements for use in a temperature-control device according to the invention; and

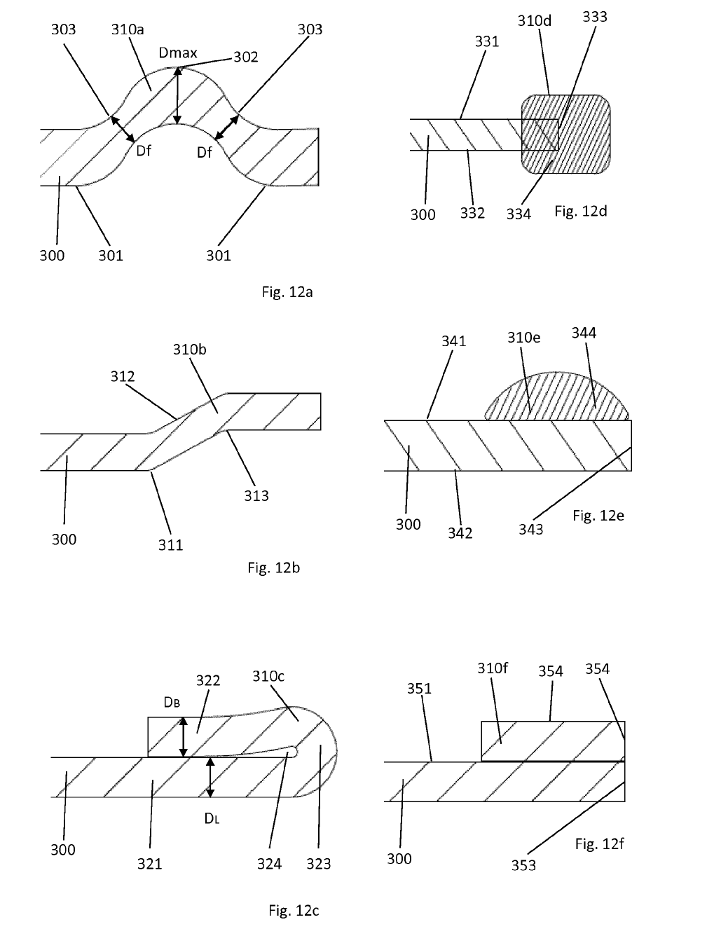

FIG. 12 shows six cross-sections of elevation elements for use in a temperature-control device according to the invention.

FIG. 1 shows a cross-section through a temperature-control device 1, wherein the cross-section shows in particular the region of a throughflow opening 2 and the spring element 100 located therein in the closed state. Shown here is a spring element 100 which is configured as part of a spring layer 145. The spring element 100 comprises a plate-shaped spring plate 110, a retaining region 120, a deflection region 130′ and a connecting region 130, all of which are integrally connected to one another, that is to say are integrally formed from the spring layer 145. At its outer circumferential region, the spring plate 110 is connected to the retaining region 120. To this end, retaining arms 125 are arranged radially on the spring plate 110, said retaining arms acting as compression springs. Sections 120a, 120b, 120c represent the cross-section through the retaining arms 125. Through-openings 124 are formed between the retaining arms 125.

At its region facing away from the spring plate 110, the retaining region 120 is connected to the deflection region 130′. The deflection region 130′ is bent at two points 132a, 132b, resulting in an angled shape of the deflection region 130′. Due to the double bend in the deflection region 130′, the connecting region 130 runs parallel to and offset from the areal extent of the spring plate 110. A through-opening 131 for the passage of heat exchanger fluid, in particular oil, is formed in the angled region 130b′ of the deflection region 130′. Therefore, in the open state of the valve, the heat exchanger fluid can flow through the through-opening 131 or through the region between the retaining arms 125, 120a, 120b, 120c. At the horizontal boundary of FIG. 1, the connecting region 130 continues into the spring layer 145, which forms the spring element. The different regions of the spring layer 145 are additionally indicated by the various brackets at the top edge of the diagram.

In the cross-section, a functional layer 300 is arranged below the layer 145 of the spring element 100, said functional layer having a similar material thickness to the material of the spring element 100 and of the spring layer 145. The functional layer 300 has a through-opening 320, which is arranged within the throughflow opening 2 or the opening cross-section of which is located within the opening cross-section of the throughflow opening, the rotation axes of the openings running coaxially. The diameter of the through-opening 320 is approximately five times smaller than the diameter of the throughflow opening 2. The spring layer 145 rests with its connecting region 130 on the functional layer 300.

The functional layer 300 has a sealing bead 315 running around the through-opening 320, the bead top 302 of said bead pointing in the direction of the spring plate 110.

The sealing bead 315 is an elevation element 310 which, together with the plastic deformation of the retaining arms 125, ensures the preloading of the spring plate. The interaction thereof exerts a preload on the spring plate 110 in the direction of the sealing bead 315, so that a specific pressure difference is necessary in order to lift the spring plate 110 away from the bead 315. Here, said bead simultaneously forms the spring plate seat 340. The sealing bead 315, together with the spring plate, also forms a sealing line in the closed state of the valve. The sealing bead 315 has a narrowing of the material thickness on its flank, so that it is not formed as an exclusively elastic sealing bead.

In the cross-section, the base plate 200 is shown above the layer 145 of the spring element 100. The circumferential wall 280 of the base plate 200 adjacent to the throughflow opening 2 delimits the throughflow opening 2 and defines the diameter thereof. The spring layer 145 with the spring element 100 is held between the base plate 200 and the functional layer 300 and thus fixes the spring element 100 in position. Typical thicknesses of the base plate can be between 0.15 mm and 8 mm. Preferred thicknesses are 0.5 mm to 4 mm, particularly preferably 0.8 mm to 1.8 mm, in each case including or excluding the stated threshold values. A section of a first heat exchanger element 800 having an inlet opening 820 is shown above the base plate 200.

FIG. 2 shows the cross-section through a further temperature-control device 1 according to the invention, in a similar illustration to FIG. 1. Particularly with regard to its opening and closing characteristic, the spring element 100 here is configured substantially the same as in the preceding embodiment. However, in contrast to FIG. 1, the spring element 100 in FIG. 2 is not an integral part of a spring layer 145 but rather is configured as a separate spring element. The functional element 100 thus has a limited diameter, which is defined by the outer circumferential region 150 of the connecting region 130.

For form-fitting connection to the connecting region 130 of the spring element 100, the base plate 200 has a cutout or recess 220, into which an outer section of the connecting region 130 of the spring element 100 is introduced. In addition, at the radially outer edge of the cutout 220 in the region of its surface facing towards the functional layer 300, the base plate is deformed at least in some sections by the outer section of the connecting region 130 so as to form a material bulge 221. The form fit is thus achieved by the recess 220 and the material bulge 221. An adjacent heat exchanger element has not been shown in FIG. 2.

FIG. 3 shows the cross-section through a further temperature-control device 1 according to the invention. Here, too, the spring element 100 is not contained in a layer but rather is configured as a separate spring element 100. In contrast to the preceding embodiments, however, there is no bent or angled deflection region 130′ between the retaining region 120 and the connecting region 130 of the spring element 100, so that, in the illustrated state in which no pressure is applied, only the retaining region 120 or the retaining arms 125 have a plastic deformation and rest on the elevation element 310 in a preloaded manner.

Once again, the connecting region 130 is fastened in a recess 220a in the base plate 200 in a form-fitting manner. However, the recess 220a of the base plate 200 in this embodiment is not arranged on the side 201 of the functional layer 300 and adjacent thereto, but rather is arranged on the side 202 of the base plate 200 opposite to the functional layer 300, adjacent to the component 400. The form fit is therefore achieved by the recess 220a and the further component 400 arranged adjacent thereto. In addition, two further components 500, 600 are shown in FIG. 3, which are located above the component 400 in the cross-section. The components 400, 500 and 600 are part of a heat exchanger element 800 having an inlet region 820.

FIG. 4 shows the cross-section through a further temperature-control device 1 according to the invention, in a similar illustration to FIG. 3. The temperature-control device 1 is similar to the variant in FIG. 3, but the fastening of the connecting region 130 differs once again. In this embodiment, a recess 220b is likewise provided in the base plate 200. However, no further component and no further layer is arranged adjacent to and above the recess 220b. To achieve a form-fitting connection of the connecting region 130 in the recess 220b, therefore, a material bulge 221 is formed on the upper surface 202′ of the base plate 200 in a manner similar to the variant in FIG. 2, said material bead surrounding the connecting region 130 in order to form a form-fitting connection from the upper side 202 of the base plate 200. Part of the side 135 of the connecting region 130 facing away from the spring plate 110 is thus formed immediately adjacent to the material bulge 221 and is surrounded by the latter; part of the surface 136 of the connecting region 130 facing towards the spring plate 110 is immediately adjacent to and surrounded by a flank 220b′ of the recess 220b. Components 400, 500, 600 and 800 are configured as in FIG. 3.

In FIG. 5, the spring element 100 and the components 400, 500, 600 and 800 are configured as in the preceding exemplary embodiment. The form-fitting connection of the connecting region 130 of the spring element 100 to the base plate 200 is also substantially the same as in the preceding exemplary embodiment. However, the base plate 200 does not only have embossments on its upper surface 202 in the region adjacent to the outer circumferential edge 150. Instead, the region adjacent to the throughflow opening 2 is also formed with a particular surface topography. Adjoining the flank 220c′ of the recess 220c, the surface runs downwards in an arc-shaped manner and forms a wide depression 213. Adjoining this towards the throughflow opening 2 is a rising region which forms an elevation element 210 and a spring plate seat 240 for the spring plate 110. The throughflow opening 2 in the base plate 200 extends on both sides of the spring plate 110.

FIG. 6 shows an exemplary embodiment of a temperature-control device 1 in which the spring element 110 is an integral part of a spring layer 145, as in the exemplary embodiment of FIG. 1. The spring layer 145 is once again received with its connecting region 130 between a functional layer 300 and the base plate 200. However, the retaining arms 125 here are not plastically pre-deformed, but rather are preloaded via a bead 115 in the spring layer 145 itself. The bead 115 forms an elevation element 141 and at the same time a spring plate seat 140. The spring plate seat 140 acts here with the region of the functional layer 300 facing towards the inner edge, said region likewise acting as a spring plate seat 340. The two spring plate seats 140, 340 thus form a sealing line. The heat exchanger element is not shown here.

FIG. 7 shows an exemplary embodiment of a temperature-control device 1 in which the spring element 100, as in FIG. 2, is formed with a spring plate 110, a plastically pre-deformed retaining region 120, a deflection region 130′ and a connecting region 130. The spring element 110 once again rests on a functional layer 300 and is preloaded via a bead 315, which at the same time forms the elevation element 310 and the spring plate seat 340. The exemplary embodiment of FIG. 7 differs from the other exemplary embodiments shown in that a connecting piece 700 is attached to the functional layer 300 which is arranged on the outwardly pointing surface 201 of the base plate 200, said connecting piece being connected to the base plate 200 via a circumferential weld seam 799 on the functional layer 300 and through the latter. This makes it possible for the connecting region 130 in this case to be received not in a cutout of the base plate 200 but rather in a cutout 720 at the end of the connecting piece pointing towards the base plate 200. At the free end 790 of the connecting piece 700, an oil-conveying hose for example can be pushed onto the connecting piece 700 or onto the free end 790 thereof.

In FIG. 8, the spring element 100 is once again an integral part of a spring layer 145. Similarly to FIG. 6, the spring layer is arranged between a functional layer 300 and a base plate 200, and the retaining region 120 is only elastically preloaded. However, the bead 315 forming the elevation element 310 is now formed in the functional layer 300 and also forms the spring plate seat 340 at the same time. Adjacent to the surface 202 of the base plate 200 pointing away from the spring element 100, said base plate has a lift-limiting element 290 which prevents excessive lifting of the spring plate 110 away from the spring plate seat 340 and thus prevents undesirable plastic deformation of the retaining region 120. The lift-limiting element 290 may be configured as a circumferential protrusion or may consist of at least one protrusion which protrudes from an edge region of the wall 280.

FIG. 9 shows a spring element 100 which, in the form shown, is independent of a spring layer 145. However, a comparable spring element 100 can also be formed in a spring layer 145. This spring element 100 is characterized in that arc-shaped lift-limiting elements 190 are formed from the sheet material of the spring element in the immediate vicinity of the retaining arms 125 and at only a slight distance therefrom. Said lift-limiting elements are cut free at their two longitudinal edges 198, 199 but are still connected to the sheet layer at their two short edges 194, 195. At the two edges 192, 193, they are bent out of the plane of the sheet layer, expose a through-opening 191 and continue to bend along their further contour so that their central region 197 is rotated through approximately 180° compared to the contour of the sheet strip in the region of the connecting edges 194, 195, and thus forms a planar abutment as a lift-limiting element 190 for a spring plate 110.

FIG. 10 shows different embodiments in respect of a layer 80 of the temperature-control device 1 with lift-limiting elements 90. Such a lift-limiting element 90 can be formed in different layers, and therefore these are not shown in detail here.

In FIG. 10a, a lift-limiting element 90 is integrally connected to a retaining region of the layer 80 via retaining arms 84a to 84d. The retaining arms are arranged in each case in a manner offset by 90° to one another. They leave a total of four through-regions 82a to 82d therebetween.

FIG. 10b shows a modification of the arrangement of FIG. 10a. The lift-limiting element 90 has in the centre an additional through-opening 82z, which can be closed by a spring plate bearing against it.

FIG. 10c shows a further lift-limiting element 90, which has through two intersecting webs consisting of partial arms 84b and 84d, and 84a and 84c. Said webs meet in the middle and form the lift-limiting element 90.

FIG. 10d shows a modification of the embodiment of FIG. 10c. It is now no longer four arms that are used, which together form two webs spanning the throughflow opening, but rather just three arms 84a to 84c, which meet in the middle of the through-opening and thus form a star-shaped lift-limiting element 90.

As shown in FIG. 6, analogous lift-limiting elements can also be formed in the spring plate 110 itself; they are denoted 140 and 141 therein, since they simultaneously assume the function of the spring plate seat and elevation element.

FIGS. 11a to 11f show different embodiments in respect of the spring layer 145 and the spring element 100. The individual embodiments in FIGS. 11a to 11f differ essentially by the design of the retaining arms 125. In FIG. 11a, these are arranged concentrically in a spiral shape. In FIG. 11b, the retaining arms 125 are likewise arranged concentrically in a spiral shape, but are wider than the retaining arms 125 in FIG. 11a and also have kinks or other pre-deformations 125a, 125a′ which influence the spring behaviour and thus the opening behaviour. FIG. 11c shows concentric retaining arms, wherein in each case successive retaining arms 125 are connected to one another at two opposite points. For connection points arranged successively in the radial direction, the connection points are in each case offset by 90° to one another.

FIG. 11d likewise shows retaining arms 125 which run concentrically, said retaining arms having a particular shape so that the fluid passage area remaining between the retaining arms 125 is sufficiently large.

FIG. 11e shows retaining arms 125 similar to those in FIG. 11d, but the number thereof is greater and in addition the retaining arms are branched.

FIG. 11f also shows concentric, branched retaining arms 125, which in each case leave sickle-shaped throughflow regions 124 therebetween for the fluid.

FIG. 12 shows six exemplary embodiments 12a to 12f in respect of spring plate seats and elevation elements 310a to 310f as an elevation element or sealing element for the spring plate 110, in each case in a sectional view of a section through the respective circumferential abutment element and/or sealing element 310, wherein the through-opening 320 adjoins the illustrated section to the right in each case. The reference sign 340, which is otherwise used for a spring plate seat in the functional layer 300, is not indicated separately, but the elements 310a to 3101 also provide this function.

FIG. 12a shows a bead 310a as is already formed in the functional layer 300 in the preceding exemplary embodiments of the temperature-control device 1. The bead has two rising flank regions 303 between two bead bottoms 301, and a bead top 302. The material thickness is, perpendicular to the neutral axis of the sheet metal, more than 25% smaller in the region of the bead flanks than the material thickness in the region of the bead top, which substantially corresponds to the material thickness in the region of the bead bottoms: D_{F}<0.75 Dₘₐₓ. This narrowing of the flank increases the rigidity of the bead, which brings about a particularly good sealing effect and reliable preloading of the spring plate, particularly also in the region above and/or below channels.

FIG. 12b shows a half-bead 310b as an elevation and/or sealing element 310. This half-bead has a rising region 312 between two kink points 311, 313.

FIG. 12c shows a flanged elevation and/or sealing element 310c. For this, the edge region 322, that is to say the free end of the layer 300, is folded back onto the region 321. This forms a new, bent edge 323. Depending on the extent of the fold, a free space 324 may remain between the flanged region 322 and the adjacent region 321. The flanged elevation and/or sealing element 310c already has, per se, sufficient rigidity to bridge channels. To increase this rigidity further, the flanged region 322 may be narrowed so that D_{B}<D_{L}.

While the embodiments of FIGS. 12a to 12c form the elevation and/or sealing element 310 from the material of the layer 300 itself, FIGS. 12d to 12f show embodiments in which an additional element forms the elevation and/or sealing element 310. This is an annularly running elastic element (FIGS. 12d and 12e) or an annularly running metal element (FIG. 12f).

In the exemplary embodiment of FIG. 12d, an elastic element 334 is applied as an elevation and/or sealing element 310d to the edge 333 pointing towards the through-opening 320, which elastic element extends from the upper side 331 of the functional layer 300, over the side edge 333, to the lower side 332 and thus forms an elevation beyond the upper and lower sides 331, 332. In contrast, in the exemplary embodiment of FIG. 12e, the elastic element 344 extends only on the upper side 341 of the functional layer 300 that faces towards the spring layer 300 in the installed situation; the side edge 343 and the lower side 342 remain free.

Finally, in FIG. 12f, a metal ring 352 is applied to the surface 351 of the functional layer 300, the edge 354 of said ring terminating flush with the edge 353. The thickness of the ring 352 and of the functional layer 300 is in this case substantially identical, but can also be selected to be different. Likewise, identical metal sheets or sheets made of different metals can be used. Preferably, the ring 352 is fastened to the functional layer 300, in particular is fastened thereto in a materially bonded manner and preferably is welded to the functional layer 300.

1-24. (canceled)

25. A temperature-control device for cooling or heating a heat exchanger fluid, comprising:
a base plate and a heat exchanger element, wherein the base plate has at least one throughflow opening as an inlet or outlet for the heat exchanger fluid,
a spring element which has a spring plate and a retaining region for the spring plate, which retaining region is connected to the spring plate and surrounds the latter at least in some regions;
a spring plate seat for abutment for the spring plate,
and optionally a receiving region for receiving the spring element in and/or adjacent to the base plate,
wherein the spring plate, in a projection of the spring plate perpendicular to the areal extent thereof, is arranged within the throughflow opening.

26. The temperature-control device according to claim 25, wherein the temperature-control device has at least one connecting piece, the opening cross-section of which is arranged so as to overlap with the opening cross-section of the throughflow opening, wherein the connecting piece, at one end, is connected to the base plate or engages through the base plate.

27. The temperature-control device according to claim 26, wherein the spring element in some sections adjoins the base plate and at least in some sections is arranged within the region delimited by the connecting piece, and/or a connecting region of the spring element is connected in a materially bonded, form-fitting and/or force-fitting manner to at least the base plate, optionally to the connecting piece, to a further layer and/or to a counterpart component.

28. The temperature-control device according to claim 25, wherein the spring plate seat for abutment for the spring plate is configured as part of the spring element, of the base plate, of an additional layer, of a further functional element, of a connecting piece and/or of a counterpart component.

29. The temperature-control device according to claim 28, wherein a through-opening arranged in the throughflow opening, wherein the spring plate seat is arranged so as to run around the through-opening.

30. The temperature-control device according to claim 25, wherein the spring plate seat has an elevation element on which the spring plate rests in some regions or around its outer circumferential edge in the state in which no pressure is applied.

31. The temperature-control device according to claim 30, wherein the elevation element on the surface of the spring plate runs around the through-opening.

32. The temperature-control device according to claim 25, wherein a first functional layer, comprising a sealing layer, which is arranged adjacent to the surface of the base plate and has a through-opening which is arranged so as to overlap with the throughflow opening.

33. The temperature-control device according to claim 26, wherein the spring plate and the retaining region and optionally the connecting region are formed integrally as part of a spring layer or of a further layer arranged adjacent to the base plate.

34. The temperature-control device according to claim 27, wherein the connecting region and/or the retaining region is arranged and/or fastened between the base plate and the optionally provided first functional layer, a further layer, the connecting piece and/or a counterpart component.

35. The temperature-control device according to claim 27, wherein the connecting region and/or the retaining region, at least in some regions, is configured to run around and adjacent to the throughflow opening.

36. The temperature-control device according to claim 35, wherein the abutment region is configured as a first recess in the base plate, in an additional layer or in a counterpart component, which recess runs around the circumferential edge of the throughflow opening at least in some sections and is set back in a step-like manner from the surface of the base plate, of the additional layer or of the counterpart component around the circumferential edge of the throughflow opening.

37. The temperature-control device according to claim 36, wherein the spring plate is pre-shaped with respect to the connecting region and/or the retaining region such that it rests on the elevation element in the state in which no pressure is applied.

38. The temperature-control device according to claim 37, wherein the spring plate, in the state in which no pressure is applied, is offset, preferably is offset by at least 0.4 mm, relative to the plane in which the connecting region and/or the retaining region extends.

39. The temperature-control device according to claim 27, wherein the spring plate is integrally connected to the connecting region and/or the retaining region via one retaining arm, two retaining arms, three retaining arms, four retaining arms or more than four retaining arms, wherein the at least one retaining arm may be branched.

40. The temperature-control device according to claim 39, wherein the retaining arms are configured as spiral-shaped retaining arms which extend between the inner circumferential edge of the connecting region or of the retaining region and the outer circumferential edge of the spring plate, optionally also around one of the circumferential edges.

41. The temperature-control device according to claim 36, wherein the spring element, one of the layers, the base plate or a counterpart component has at least one travel-limiting element for limiting the travel of the spring plate in one or both directions perpendicular to the areal extent of the spring plate.

42. The temperature-control device according to claim 41, wherein the travel-limiting element is formed integrally with the spring element.

42. The temperature-control device according to claim 42, wherein the travel-limiting element is formed by at least one simply formed web, arm or region of the spring element, and the parallel projection of which in the direction of the lifting direction of the spring plate is arranged so as to overlap with the spring plate.
